(19) United States
(12) Patent Application Publication
(10) Pub. No.: US 2023/0041606 A1
(43) Pub. Date: Feb. 9, 2023

(54) AUTOMATIC SCOPE RETICLE BORE-SIGHTING FOR RIFLE MOUNTED CLIP-ON FIRE CONTROL SYSTEMS

(71) Applicant: Cubic Corporation, San Diego, CA (US)

(72) Inventors: Tony J. Maryfield, Poway, CA (US); Mahyar Dadkhah, San Diego, CA (US); Christian Marcello Cugnetti, San Diego, CA (US); Michael Andre Roes, San Diego, CA (US)

(21) Appl. No.: 17/880,447

(22) Filed: Aug. 3, 2022

Related U.S. Application Data
(60) Provisional application No. 63/228,995, filed on Aug. 3, 2021.

(51) Int. Cl. F41G 1/38; F41G 1/473

(52) U.S. Cl. CPC F41G 1/38; F41G 1/473

(57) ABSTRACT

An automatically aligning riflescope display adapter (RDA) system can illuminate toward an eyepiece with a beam from a light emitter. The RDA system can activate a display which includes an electronic reticle visible through the eyepiece. Additionally, the RDA system can track, with a tracking sensor, a location of a scope reticle based on back reflection of the beam from direction of the eyepiece. The RDA system can detect an amount of optical misalignment between the scope reticle and rhe electronic reticle. The RDA systen can align the scope reticle with the electronic reticle.

This application claims the benefit of U.S. Provisional Application Serial No. 63/228,995 by Maryfield et al., filed on Aug. 3, 2021, entitled “AUTOMATIC SCOPE RETICLE BORE-SIGHTING FOR RIFLE MOUNTED CLIP-ON FIRE CONTROL SYSTEMS,” the disclosure of which is incorporated by reference herein in its entirety.

### BACKGROUND OF THE INVENTION

This disclosure relates in general to optical scopes and, but not by way of limitation, to improved bore sighting.

A class of optics have been developed that can assist with the task of targeting a desired aimpoint across large distances. The class is referred to as “smart scopes”. Smart scopes can include electro-optic attachments to rifles. The smart scopes can determine and present an aiming solution. Each scope component can have a zero location and all components need calibration such that all of the zero locations are aligned. A calibration process can take time and divert attention of a user away from the user’s objective.

### BRIEF SUMMARY OF THE INVENTION

An example method of automatically aligning a riflescope display adapter (RDA) with an optical scope with an automatically aligning RDA, according to the description, comprises illuminating toward an eyepiece with a beam from a light emitter. The method further includes activating a display comprising an electronic reticle visible through the eyepiece. The method also includes detecting, with a tracking sensor, a location of a scope reticle based on back reflection of the beam from the direction of the eyepiece. The method further includes detecting an amount of optical misalignment between the scope reticle and the electronic reticle. The method also includes aligning the scope reticle with the electronic reticle.

An example automatically aligning RDA system, according to the description, comprises a light emitter configured to illuminate an eyepiece with a beam. The RDA system further comprises a display comprising an electronic reticle visible through the eyepiece. The RDA system further comprises a tracking sensor configured to detect a location of a scope reticle based on back reflection of the beam from the direction of the eyepiece. The RDA system further includes an RDA controller communicatively coupled to the light emitter, the display and the tracking sensor and configured to perform operations including causing the light emitter to illuminate the eyepiece with the beam. The RDA controller operations further include activating the display. The RDA controller operations further include detecting, with the tracking sensor, the location of the scope reticle. The RDA controller operations further include detecting an amount of optical misalignment between the scope reticle and the electronic reticle. The RDA controller operations further include aligning the scope reticle with the electronic reticle.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a block diagram of an automatically aligning riflescope display adapter (RDA), according to an embodiment.

FIG. 2 is an illustration of optical components within an automatically aligning a RDA, according to an embodiment.

FIG. 3 is a simplified illustration of the basic operation of an automatically aligning a RDA, according to an embodiment.

FIG. 4 is a process flow diagram of a method of automatically aligning a RDA, according to an embodiment.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

“Smart scopes” is a class of fire control riflescopes that provides an overlay of the ballistically corrected aiming coordinates based on target range, gun/bullet type, and atmospheric conditions. A “clip-on display” or riflescope display adapter (RDA) instantly converts a traditional riflescope into a “smart scope” with an illuminated electronic focal plane display projected into the riflescope with a 45° beam splitter in the objective space. The electronic aimpoint is unaffected by any adjustments of the riflescope, including zoom or reticle movements made by twisting the elevation and windage turrets. This is both an advantage and disadvantage in that the aimpoint can be instantly updated by a ballistic solver, but the zero’d location cannot be displayed without a bore-sighting procedure that aligns the electronic display to the scope reticle/gun/bullet 100 m zero position. This procedure includes adjustments to the display for rotation, horizontal, vertical, and gain (expansion) of the electronic reticle to match the scale factor and zero of the scope reticle grid.

Conventionally, the shooter performs a manual adjustment procedure to align his display to the scope. And this must be done every time the display is re-installed or if the display has inadvertently shifted out of alignment due to gun shocks. In the best case, it is an inconvenience for the shooter. In the worst case, it could be harmful that the alignment could have shifted without the user knowledge and now the shooter is taking shots at incorrect aimpoints.

In one embodiment, a solution is presented here that automatically self-aligns the electronic display to the scope reticle. In this method, a camera, 880 to 904 nm infrared illumination LED, and lenses are added in the same path to the display from the scope’s 45° beam splitter. The IR LED projects into the scope, and the back reflection from the shooter’s retina back illuminates the scope reticle. The now clearly readable scope reticle is focused onto the CMOS camera. Image processing finds the geometric center of the grid, the horizontal and vertical cross-hairs, and tics by associating the angular locations of the camera focal plane array to the electronic display, which is also a focal plane display. The horizontal, vertical, scale factor, and rotation offsets are calculated and applied to the display for a 1:1 match. This entire process would likely be embodied with some type of calibration button that is pressed by the user, or it can be applied continuously for real-time updates. The high sensitivity CMOS camera may include a visible bandpass filter to avoid interference with daytime light. The IR LED illumination is unconditionally eye safe.

This embodiment automatically self-aligns the clip-on electronic display to the riflescope, and re-using key components already in the display, e.g. the 45° beam splitter. A low-cost camera, and IR illumination LED, and some minor optics makes this possible for high volume commercial or military applications. The shooter no longer needs to manually recalibrate the electronic display to the riflescope to his original scope/rifle zero at 100 m to range the target in this embodient. This reduces target engagement time, allowing rapid updates and timely shots to the target.

Embodiments provide a safety benefit, in that automatically compensates the display for any given mechanical shift effect and can provide an alarm to alert the user if it has exceeded compensation limits of the display. This may avoid making shots at wrong targets due to inadvertent boresight drifts caused by gun shocks, or slippage in the display adapter hardware on the scope.

Other features (manual re-calibration) can be applied to accommodate for user readjustment of the scope turret adjustments shooters need for long range, magnified shots.

Provides the ability to track the scope reticle in real time and compensate for possible shifts in the rifle display mounting hardware.

In one embodiment, the shooter no longer needs to boresight the clip on display to the riflescope, since this feature makes it automatic. The system can alert the user if the system has drifted and or drifted too far that it cannot compensate sufficiently for accurate aimpoints.

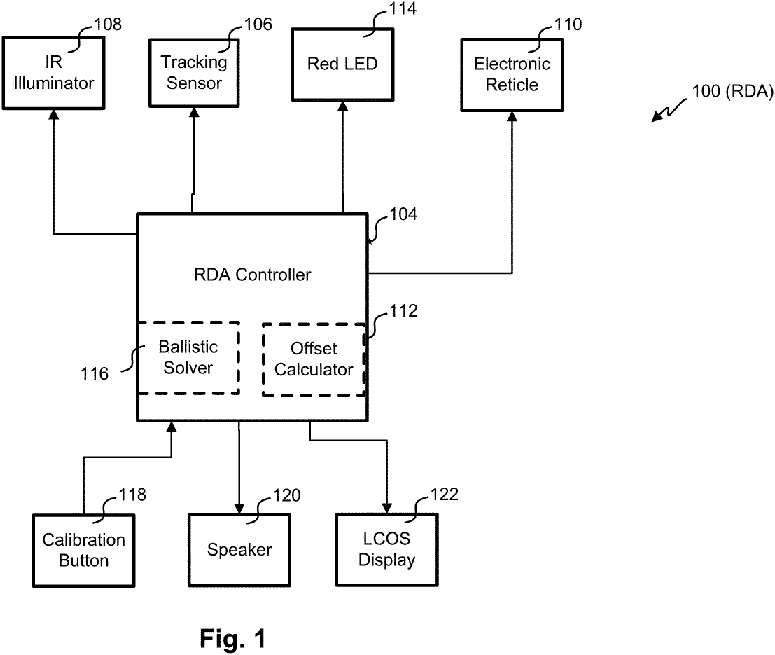

FIG. 1 is a block diagram of an automatically aligning RDA 100, according to an embodiment. As with other figures provided herein, FIG. 1 is provided as a non-limiting example. Embodiments may include some components that are not illustrated (e.g., a power supply). Moreover, alternate embodiments may combine, separate, rearrange, or otherwise alter the configuration of components illustrated in FIG. 1. Arrows between components illustrate electronic, data flow and/or optical connections between components.

An RDA controller 104 may comprise one or more processors generally configured to cause the various components of the RDA 100 to automatically align the RDA 100 with an optical scope 206, calculate a ballistic solution (according to some embodiments), and operate a user interface. The RDA controller 104 may comprise without limitation one or more general-purpose processors (e.g. a central processing unit (CPU), microprocessor, and/or the like), one or more special-purpose processors (such as digital signal processing (DSP) chips, application specific integrated circuits (ASICs), and/or the like), and/or other processing structure or means.

One or more individual processors within the RDA controller 104 may comprise memory, and/or the RDA controller 104 may have a discrete memory (not illustrated). In any case, the memory may comprise, without limitation, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The RDA controller 104 can comprise a ballistic solver 116 and an offset calculator 112. The RDA controller can be communicatively coupled via electrical and/or optical connections to a tracking sensor 106, an infrared (IR) illuminator 108, an electronic reticle 110, a red light emitting diode (LED) 114, a calibration button 118, a speaker 120, and a liquid crystal on silicon (LCOS) display 122. In some examples, the tracking sensor 106 can track a location of a scope reticle 210 that is back illuminated by a beam from the IR illuminator 108. The tracking sensor can also track the location of the electronic reticle 110. In some examples, the electronic reticle 110 is a component of the LCOS display 122 and the LCOS display is illuminated by a red beam from the red LED.

The RDA controller 104 can detect, with the tracking sensor 106, an amount of optical misalignment between the scope reticle 210 and the electronic reticle 110 using the offset calculator 112. The RDA controller 104 can determine if the amount of misalignment exceeds predetermined maximum offset. If the maximum offset is exceeded, an RDA controller 104 can notify the user of excessive misalignment with an alarm through the speaker 120. In some examples, the RDA controller 104 can align the scope reticle 210 with the electronic reticle 110. Aligning the scope reticle 210 can involve moving electronic display elements across an imaging array. In some examples, alignment can occur continuously. In some examples, alignment can be triggered when the user engages the calibration button 118. The RDA controller 104 can additionally provide a ballistic solution based on a distance determination as well as environmental factors using the ballistic solver 116.

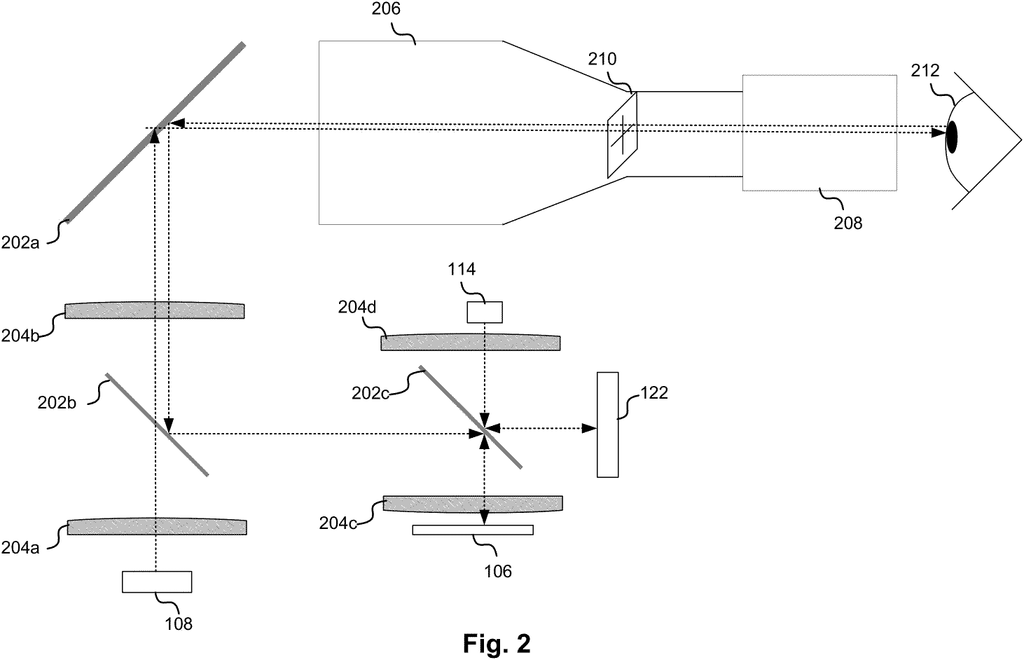

FIG. 2 is an illustration of optical components within an automatically aligning RDA 100, according to an embodiment. In this example, an infrared (IR) beam from an IR illuminator passes through a lens 204a, a beam splitter 202b, and a lens 204b before reaching a beam splitter 202a. The IR beam reflects off the beam splitter 202a, passes through a scope reticle 210 and an eyepiece 208 within an optical scope 206 before reaching an eye 212 of a user. The IR beam reflects off the eye 212 and back illuminates the scope reticle 210. The IR beam retraces a path to the beam splitter 202a. The IR beam reflects off beam splitter 202a, passing through the lens 204b before reflecting off the beam splitter 202b. A portion of the IR beam reflects off a beam splitter 202c, passes through lens a 204c and reaches a tracking sensor 106. Another portion of the IR beam passes through the beam splitter 202c and continues along an optical path to a liquid crystal on silicon (LCOS) display 122.

In this example, a visible beam from a red LED 114 reflects off the beam splitter 202c and illuminates the LCOS display 122. A portion of the visible beam reflects off the LCOS display, passes through the beam splitter 202c and reflects off the beam splitter 202b. The portion of the visible beam then reflects off the beam splitter 202b, passes through the lens 204b and reflects off the beam splitter 202a. The visible beam continues along an optical path to the eye 212 of the user, passing through the scope reticle 210 and the eyepiece 208 of the optical scope 206. The visible beam can allow the user to see the LCOS display 122. The LCOS display 122 can include an electronic reticle 110.

The tracking sensor 106 can track the location of the scope reticle 210 based on the back reflection of the IR beam from direction of the eyepiece 208. The tracking sensor 106 can compare the location of the scope reticle 210 to a location of the electronic reticle 110 of the LCOS display 122. In some examples, the tracking sensor 106 can detect an amount of optical misalignment between the scope reticle 210 and the electronic reticle 110. An RDA controller 104 (not shown) can align the scope reticle 210 with the electronic reticle 110.

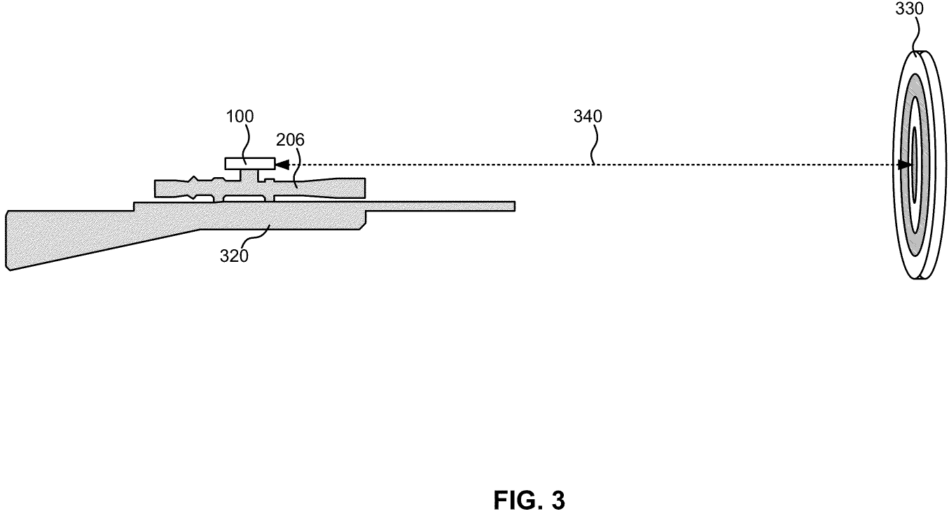

FIG. 3 is a simplified illustration of the basic operation of an automatically aligning RDA 100, according to an embodiment. The RDA 100 and an optical scope 206 may be bore sighted to a weapon 320, allowing a user to use the optical scope 206 to aim the weapon 320 at a target 330 that is a distance 340 from the RDA 100. In some examples, the RDA 100 removably attaches to the optical scope 206. The user can calibrate or “zero” a scope reticle 210 of the optical scope 206 for accurate aim of the target 330 at the distance 340. An electronic reticle 110 associated with the RDA 100 can be automatically aligned with the scope reticle 210.

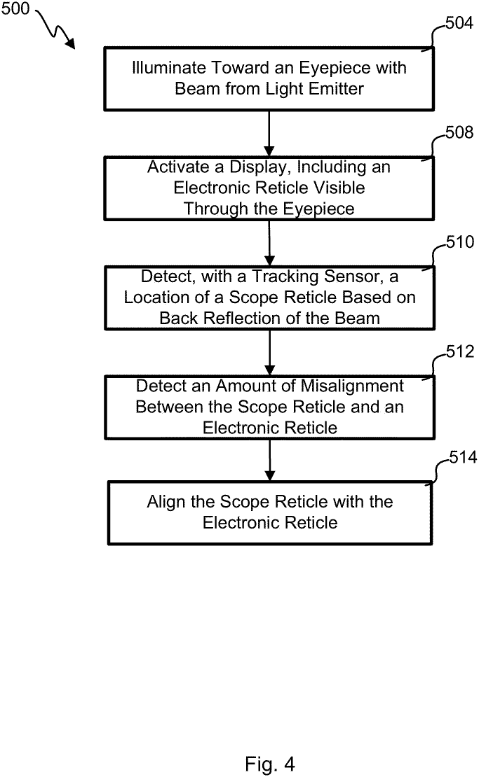

FIG. 4 is a process flow diagram of a method 500 of automatically aligning a RDA 100, according to an embodiment. Here, the functionality of the blocks illustrated in FIG. 4 may be performed by one or more components of the RDA 100, such as the components illustrated in FIGS. 1 and 3.

At block 504, the functionality includes illuminating toward an eyepiece 208 with a beam from a light emitter. In some examples, the beam can be an infrared (IR) beam from an IR illuminator 106. The beam can be directed towards the eyepiece 208 through a 45 degree beam splitter 202a placed in front of an optical scope 206. By passing the beam through the beam splitter 202a, the user can make adjustments to the optical scope 206 without affecting an optical path of the beam.

The functionality at block 508 comprises activating a display, including an electronic reticle 110 visible through the eyepiece 208. In some examples, activating the display can comprise illuminating the display using a visible light source. In some examples, the visible light source can be a red light emitting diode (LED) 114 and the display can be a liquid crystal on silicon (LCOS) display 122. In some examples, the electronic reticle 110 of the display can be detected by a tracking sensor 106.

At block 510, the functionality includes detecting, with the tracking sensor 106, a location of a scope reticle 210 based on back reflection of the beam. In some examples, the beam is reflected back towards the scope reticle 210 from an eye 212 of a user. In some examples, the tracking sensor 106 is a camera or focal plane array. The tracking sensor 106 can detect IR in some examples. The tracking sensor 106 can track a location of the electronic reticle 110 as well as the location of the scope reticle 210.

At block 512, the functionality includes detecting an amount of misalignment between the scope reticle 210 and the electronic reticle 110. In some examples, an offset calculator 112 can check to determine if the amount exceeds a predetermined maximum offset. If the maximum offset is exceeded, an RDA controller 104 can notify the user of excessive misalignment with an alarm through a speaker 120.

At block 514, the functionality includes aligning the scope reticle 210 with the electronic reticle 110. In some examples, aligning the scope reticle 210 with the electronic reticle 110 includes moving electronic display elements across an imaging array. Alignment can be sensed by the tracking sensor 106 when the location of the scope reticle 210 matches the location of the electronic reticle 110 within the resolution of the tracking sensor 106. In some examples, alignment can occur continuously. In some examples, alignment can be triggered when the user engages a calibration button 118.

The RDA 100 can additionally provide a ballistic solution based on a distance determination as well as environmental factors. As such, according to some embodiments, the method 500 may further comprise obtaining environmental information from an environmental sensor and determining, with a ballistic solver 116 the RDA controller 104, a ballistic solution based on the determined distance from the target and the information from the environmental sensor. The environmental sensor itself may comprise one or more types of sensors configured to sense one or more types of environmental factors. According to some embodiments, for example, the environmental sensor comprises an inclinometer, thermometer, barometer, humidity sensor, compass (e.g., magnetometer), wind sensor, or any combination thereof. In some embodiments, the method 500 may further comprise causing a display of the RDA 100 to show the ballistic solution.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electromechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made only by way of example and not as limitation on the scope of the disclosure.

What is claimed is:

1. An auto-alignment method for a riflescope display adapter (RDA), the method comprising:
illuminating toward an eyepiece with a beam from a light emitter;
activating a display comprising an electronic reticle visible through the eyepiece;
detecting, with a tracking sensor, a location of a scope reticle based on back reflection of the beam from direction of the eyepiece;
detecting an amount of optical misalignment between the scope reticle and the electronic reticle; and
aligning the scope reticle with the electronic reticle.

2. The auto-alignment method of claim 1 further comprising:
determining the amount of optical misalignment exceeds a predetermined amount; and
notifying a user of excessive misalignment.

3. The auto-alignment method of claim 1, wherein the RDA removably attaches to a scope.

4. The auto-alignment method of claim 1, wherein the tracking sensor is a camera or a focal plane array.

5. The auto-alignment method of claim 1, wherein aligning the scope reticle comprises moving electronic display elements across an imaging array.

6. The auto-alignment method of claim 1, wherein activating the display comprises illuminating the display with a beam from a visible light emitting diode (LED).

7. The auto-alignment method of claim 1, wherein the light emitter is an infrared (IR) illuminator.

8. An automatically aligning riflescope display adapter (RDA) system comprising:
a light emitter configured to illuminate an eyepiece with a beam;
a display comprising an electronic reticle visible through the eyepiece;
a tracking sensor configured to detect a location of a scope reticle based on back reflection of the beam from direction of the eyepiece; and
an RDA controller communicatively coupled to the light emitter, the display, and the tracking sensor and configured to perform operations comprising:
causing the light emitter to illuminate the eyepiece with the beam,
activating the display,
detecting, with the tracking sensor, the location of the scope reticle,
detecting an amount of optical misalignment between the scope reticle and the electronic reticle, and
aligning the scope reticle with the electronic reticle.

9. The RDA system of claim 8, the operations further comprising:
determining the amount of optical misalignment exceeds a predetermined amount; and
notifying a user of excessive misalignment.

10. The RDA system of claim 8, wherein the RDA removably attaches to a scope.

11. The RDA system of claim 8, wherein the tracking sensor is a camera or a focal plane array.

12. The RDA system of claim 8, wherein aligning the scope reticle comprises moving display elements across an imaging array.

13. The RDA system of claim 8, wherein activating the display comprises illuminating the display with a beam from a visible light emitting diode (LED).

14. The RDA system of claim 8, wherein the light emitter is an infrared (IR) illuminator.

15. A non-transitory computer-readable medium comprising instructions executable by a riflescope display adapter (RDA) controller of an automatically aligning RDA for causing the RDA controller to perform operations comprising:
causing a light emitter to illuminate an eyepiece with a beam;
activating a display comprising an electronic reticle visible through the eyepiece;
detecting, with a tracking sensor, a location of a scope reticle based on back reflection of the beam from direction of the eyepiece;
detecting an amount of optical misalignment between the scope reticle and the electronic reticle; and
aligning the scope reticle with the electronic reticle.

16. The non-transitory computer-readable medium of claim 15, the operations further comprising:
determining the amount of optical misalignment exceeds a predetermined amount; and
notifying a user of excessive misalignment.

17. The non-transitory computer-readable medium of claim 15, wherein the RDA removably attaches to a scope.

18. The non-transitory computer-readable medium of claim 15, wherein the tracking sensor is a camera or a focal plane array.

19. The non-transitory computer-readable medium of claim 15, wherein aligning the scope reticle comprises moving display elements across an imaging array.

20. The non-transitory computer-readable medium of claim 15, wherein the display is a visible light emitting diode (LED) display.
